(19) United States
(12) Patent Application Publication
(10) Pub. No.: US 2006/0229800 A1
(43) Pub. Date: Oct. 12, 2006

(54) System and method for reducing traffic congestion and accidents on highways

(76) Inventor: Gennady Aronin, Boca Raton, FL (US)

Correspondence Address: Robert M. Downey, Esq., Suite 300, 601 South Federal Highway, Boca Raton, FL, 33432, US

(21) Appl. No.: 11/104,022

(22) Filed: Apr. 12, 2005

(51) Int. Cl. G06G 7/76

(52) U.S. Cl. 701/117; 340/936

(57) ABSTRACT

In a multiple lane highway, the minimum speed and maximum speed (i.e. speed limit) which motorists are permitted to drive is progressively increased from the right lane to the furthest left lane. For instance, in a four-lane highway, the right lane may have a speed limit of 55 mph, the next lane would have a minimum speed requirement of 55 mph, the third lane would have a minimum speed requirement of 65 mph and the furthest left lane would have a minimum speed requirement of 75 mph. Drivers with less experience, or those who wish to drive at slower speeds, use the right lane. More experienced drivers with no infractions or driver license restrictions are permitted to move over and drive in progressively higher speed lanes according to pre-established guidelines and regulations requiring driver license endorsement or other approval by the state regulating authority, such as the Department of Motor Vehicles.

### BACKGROUND OF THE INVENTION

1. Field of the Invention

This invention relates, generally, to the field of automobile traffic regulation and, more particularly, to a multiple lane highway system that provides different minimum speed requirements in each lane for reducing traffic congestion and accidents.

2. Discussion of the Related Art

It is well accepted that the number of cars traveling on the world's highways increases every year. The inevitable result has been a steady increase in traffic congestion and accidents, particularly in and around major metropolitan areas. In recent years, various means have been adopted for reducing traffic congestion, however, the problem remains and continues to increase in severity as the population level grows. One particular traffic control system that has been adopted by most major metropolitan areas is the carpool lane, referred to as the HOV (high occupancy vehicle) lane in some states. The carpool lane is typically found on multiple lane highways passing through more densely populated cities and towns, including major metropolitan areas. In most instances, the furthest left lane is designated as the carpool or HOV lane and requires at least two occupants in each vehicle traveling in that lane. Law enforcement authorities often patrol highways during rush hour, when the multiple vehicle occupant requirements are in effect, to insure compliance by motorists traveling in the carpool lane. However, since most Americans do not like to carpool, the implementation of the carpool lane has had limited success in reducing traffic congestion. Often, the cars traveling in the HOV lane are found to move at the same pace as the traffic in the other lanes. A traffic slowdown in the HOV lane may be the result of an accident in that lane, the adjacent lane or on the shoulder of the highway. More often, though, the tie up in the HOV lane is a result of one or more carpool motorists traveling at a slow speed in the HOV lane. In this situation, trailing motorists are usually unable to pass the slow moving cars in the HOV lane, especially if the adjacent lane to the right is backed up with traffic.

In many instances, traffic on highways is a result of one or more accidents. Other times, particularly during rush hour, traffic movement just slows down. One reason for traffic congestion may be that there are simply too many cars traveling on the highway at the same time. When this happens, the traffic density results in an inevitable slowdown as motorists enter the highway, change lanes and travel at varying speeds. Other times, the traffic congestion may be a result of a smaller number of motorists traveling at slower speeds in all of the lanes of the highway, holding up the cars behind them. In this instance, drivers who do not like to drive at slower speeds become impatient and attempt to change lanes and maneuver around the slower drivers, sometimes in a very risky fashion, which in turn creates a hostile environment that is conducive to accidents. However, those cautious drivers, feeling comfortable traveling at slower speeds, usually pay little attention to the traffic backing up behind them. Rather than remaining in the right lane, slow drivers unfortunately move into the middle and left lanes and remain there while traveling at slower speeds. Logically, if slower drivers would remain in the right lane, the middle and left lanes would be opened up to motorists traveling at faster speeds which, in turn, would create a better traffic flow and reduce stress and road rage on the highway.

Drivers traveling on today's highways have varying levels of experience, driving ability and reflexes or reaction time. Realizing this, the speed regulations on highways could be changed to facilitate a better driving environment for motorists of all levels of driving ability.

### SUMMARY OF THE INVENTION

The present invention is directed to a system and method for reducing traffic congestion and accidents on a multiple lane highway. According to the system and method of the present invention, the minimum speed and maximum speed (i.e. speed limit) which motorists are permitted to drive is progressively increased from the right lane to the furthest left lane. For instance, in a four-lane highway, the right lane may have a speed limit (i.e. maximum speed) of 55 mph, the next lane would have a minimum speed requirement of 55 mph, the third lane would have a minimum speed requirement of 65 mph and the furthest left lane would have a minimum speed requirement of 75 mph. Drivers with less experience, or those who wish to drive at slower speeds, use the right lane. More experienced drivers with no infractions or driver license restrictions are permitted to move over and drive in progressively higher speed lanes according to pre-established guidelines and regulations requiring driver license endorsement or other approval by the state regulating authority, such as the Department of Motor Vehicles.

### BRIEF DESCRIPTION OF THE DRAWINGS

For a fuller understanding of the nature of the present invention, reference should be made to the following detailed description taken in conjunction with the accompanying drawings in which:

FIG. 1 is a diagram depicting a multiple lane highway with each lane having a different speed level according to the system and method of the present invention.

### DETAILED DESCRIPTION OF THE PREFERRED EMBODIMENTS

Most highways have between three to five lanes in each direction, especially in metropolitan areas. This would allow for each lane to be used for a different level of driving ability and experience. For example, on a four-lane highway, the speed limit is typically between 55 mph and 70 mph. However, since motorists of all levels of driving ability are presently driving in all lanes, more skilled motorists are sometimes unable to travel at the speed limit, even in the left lane.

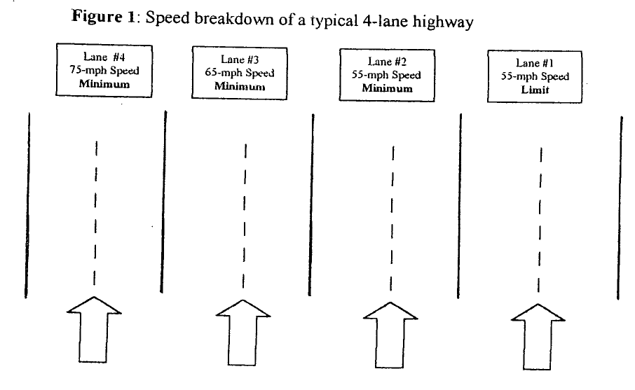

The system of the present invention provides for varying speed limits in each lane. More particularly, the present invention provides for a progressively increasing minimum speed and maximum speed (i.e. speed limit) beginning from the right lane and moving to the furthest left lane. Referring to FIG. 1 for example, the right lane may have a speed limit of 55 mph. Preferably, the right lane would also have a minimum speed requirement of 40 mph. The next lane (i.e. adjacent to the right lane) would have a minimum speed requirement of 55 mph. This would require drivers in this second lane to travel at a speed which is at least equal to the fastest moving cars in the right lane. State Troopers or other law patrolling law enforcement authorities would ticket drivers, with a fine, who drive in this second lane at a speed below 55 mph. For safety reasons, and to maintain order, the second lane, as well as all other lanes, would also have a speed limit. In the present example, the second lane may have a speed limit of 65 mph. Thus, drivers traveling in this second lane would need to maintain their speed between 55 mph and 65 mph.

The third lane over from the right has a minimum speed limit of 65 mph. Again, this means that motorists traveling in the third lane would need to travel at a speed at least equal to or faster than the fastest moving cars in the second lane. This third lane may also have a speed limit. For purposes of example, the speed limit in the third lane may be 75 mph.

Moving over to the furthest left lane (i.e. lane 4), the speed minimum is 75 mph. Again, all drivers in this fourth lane must travel at least 75 mph or remain in the middle lanes or right lane. Drivers who do not obey the speed regulations and drive below the minimum speed for that particular lane would be ticketed and fined by law enforcement authorities. Naturally, when a vehicle is traveling at a slow speed in any lane, other cars traveling behind the slow moving car are forced to also travel at the slow speed unless they can safely pass in an adjacent lane. If a driver is traveling below the minimum speed, and thus violating the minimum speed requirement for a particular lane, he/she will most probably be holding up traffic in the same lane. Drivers traveling behind the violating vehicle would not be ticketed even though they may be moving at a speed below the minimum speed in that lane because they are being prevented from moving faster by the violating vehicle. To assist in identifying slow moving drivers, regulating authorities will need to establish a predetermined acceptable distance between cars traveling in the same lane. Naturally, the distance between two cars will vary depending upon the speed minimum and speed limit in a particular lane. An example of an acceptable distance between two cars traveling at a minimum speed of 65 mph. is 175 feet. If a vehicle is driving below the speed minimum and is holding up other cars, and there are no vehicles traveling in front of the lead slow moving vehicle within the acceptable predetermined distance, then patrolling law enforcement authorities can easily identify the vehicle responsible for holding up traffic and ticket that particular driver. In order to prevent drivers from traveling at excessively high speeds which are unsafe regardless of driver ability, the fourth lane may also have a speed limit. This speed limit could vary depending upon the population density, road condition, topography and weather conditions.

The system of the present invention has the following benefits in reducing traffic congestion and accidents on highways:

Safely increases speed from one lane to the next, while also maintaining safe and orderly traffic flow in general.

Decreases the amount of time drivers spend on the highway by reducing traffic congestion.

Reduces the amount of lane changes of cars traveling on the highway, particularly faster drivers attempting to move past slower drivers, thereby reducing the number of accidents.

Allows each driver to select a comfortable speed lane and travel at the desired speed without being pressured or threatened by drivers traveling behind them.

Reduces the level of stress and road rage on highways.

Reduces overall gasoline consumption by reducing time spent on the highway and allowing cars to travel at more fuel efficient speeds.

Results in the production of less pollution by reducing the amount of time each car spends on the highway.

Naturally, as often happens with the implementation of a new plan, the system of the present invention may have negative impacts in its beginning stages. However, with time, drivers will get accustomed to the new driving patterns. Many drivers that have never driven faster than 55 mph may try to drive faster, as they see empty lanes to their left. Some of these drivers will be able to handle higher speeds, however, others will find this too dangerous and may, in fact, cause accidents. To control this problem, law enforcement will need to institute measures which keeps the less skilled drivers in the slower lanes. For instance, a new driver should be restricted to traveling only the two right lanes. After a predetermined period of time (e.g. one year after receiving a driver's license), the driver may be permitted to move over to the further lane to the left provided they have no accidents on their driving record. As the experience level of each driver increases over time, without accidents, the driver would be upgraded to permit them to drive in the faster moving lanes. However, if a driver is found guilty of causing an accident, they may be penalized and restricted to slower lanes. For example, with every accident, a driver may be required to move over one or more traffic lanes to the right. After a certain number of years (e.g. three years) of accident-free driving, the driver would regain the privilege of driving in the faster lane, by moving one or more lanes to the left. Only drivers with the highest level of skill and experience, with no accidents, would be permitted to travel in the furthest left lane (i.e. lane 4). For instance, after nine years of accident-free driving, a driver would receive an endorsement on his/her license permitting them to drive in the left most lane.

If a driver is pulled over by law enforcement, and the driver is found to be driving in a restricted lane without the proper driver license endorsement, a warning would be issued for the first time offense with an explanation of the consequences of future speed lane violations. A second violation may entail a fine and/or a short term driver license suspension. Each future violation would result in a higher fine and a longer term license suspension. In the event the driver was traveling in a restricted lane, without the proper driver license endorsement, and that driver is found to cause an accident, the consequences would be more severe.

Due to the danger of large trucks traveling at high speeds, the system of the present invention would restrict vehicles with more than two axles to use only the two lanes furthest to the right. This would impose an automatic speed limit for large trucks (i.e. three or more axles) of up to 65 mph. The revoke license penalty would be particularly effective in deterring lane violations by trucks, as this may impact the truck driver's income and livelihood. Over time, every state and/or country could adjust speed minimums and speed limits in lanes, according to traffic needs on any particular section of a highway based on traffic studies and analysis.

While the instant invention has been shown and described in accordance with a preferred and practical embodiment thereof, it is recognized that departures from the instant disclosure are contemplated within the spirit and scope of the present invention.

What is claimed is:

1. A method for reducing traffic congestion and accidents on a multiple lane highway comprising the steps of:
establishing a maximum speed limit in a first lane furthest to the right; and
establishing progressively increasing minimum speed levels in each lane moving successively from the first right lane, wherein the furthest lane to the left has the highest established minimum speed level.

2. A method as recited in claim 1 comprising the further step of:
establishing progressively increasing maximum speed limits in each lane moving successively from the first right lane, wherein the furthest lane to the left has the highest maximum speed limits.

3. A system for reducing traffic congestion and accidents on a multiple lane highway, said system comprising:
a right lane having a first speed limit; and
at least one additional lane to the left of said right lane having a minimum speed level equal to the speed limit of said right lane.

4. The system as recited in claim 3 further comprising:
a plurality of additional lanes to the left of said right lane, including at least one middle lane and one furthest left lane; and
said at least one middle lane having a minimum speed level equal to the speed limit of said right lane; and
said furthest left lane having a minimum speed level greater than said minimum speed level of said middle lane.

5. The system as recited in claim 4 wherein said at least one middle lane has a second speed limit that is greater than said first speed limit; and
said furthest left lane has a third speed limit which is greater than said second speed limit and said first speed limit, and said third speed limit being greater than said minimum speed levels in either of said at least one middle lane and said furthest left lane.

6. The system as recited in claim 3 wherein said at least one additional lane has a second speed limit which is greater than said first speed limit and the minimum speed level.

7. A system for reducing traffic congestion and accidents on a multiple lane highway, said system comprising:
a right lane having a first minimum speed level and a first maximum speed limit; and
at least one additional lane to the left of said right lane having a minimum speed level which is higher than said first minimum speed level of said right lane.

8. The system as recited in claim 7 further comprising:
a plurality of additional lanes to the left of said right lane including at least one middle lane and a furthest left lane; and
said at least one middle lane having a second minimum speed level which is higher than said first minimum speed level of said right lane; and
said furthest left lane having a third minimum speed level which is higher than said second minimum speed level and said first minimum speed level.
